(19) United States
(12) Patent Application Publication
(10) Pub. No.: US 2005/0047791 A1
(43) Pub. Date: Mar. 3, 2005

(54) Dispersion compensation control method and apparatus thereof and optical transmission method and system thereof

(76) Inventor: Tetsuya Miyazaki, Tokyo (JP)

Correspondence Address: CHRISTIE, PARKER & HALE, LLP, PO BOX 7068, PASADENA, CA, 91109-7068, US

(21) Appl. No.: 10/917,096

(22) Filed: Aug. 11, 2004

(30) Foreign Application Priority Data
Aug. 29, 2003 (JP) 2003-307030

(51) Int. Cl. H04B 10/12

(52) U.S. Cl. 398/147

(57) ABSTRACT

An optical transmitter transmits an OTDM signal light on which a spectrum component of a predetermined frequency is superimposed into an optical transmission line. A photodetector in an optical receiver converts the OTDM signal light output from the optical transmission line into an electrical signal. An electric bandpass filter extracts a component having the predetermined frequency out of the output from the photodetector. An RF power monitor measures power of the predetermined frequency component out of the output from the filter. A controller controls first an amount of dispersion compensation of a chromatic dispersion compensator so that the power of the predetermined frequency component becomes lower, and thereafter a dispersion slope of the chromatic dispersion compensator so that the power of the predetermined frequency component becomes lower.

### CROSS REFERENCE TO RELATED APPLICATIONS

This application claims priority to Japanese Patent Application No. 2003-307030, filed Aug. 29, 2003, the entire contents of which are incorporated herein by reference.

### FIELD OF THE INVENTION

This invention relates to a method and apparatus to control dispersion compensation, and an optical transmission method and system thereof.

### BACKGROUND OF THE INVENTION

In optical fiber transmission systems, a bit rate as fast as 160 Gbps or more per wavelength is about to be realized. However, since response speed of an electric receiver is at most 50 to 60 GHz, it is impossible to extract clocks to establish synchronization even if optical pulse signals of 160 Gbps or more are directly received.

In an optical fiber transmission system using an ultra high-speed optical pulse signal, for example an optical pulse signal of 160 Gbps, in which photoelectric conversion is difficult, it is necessary to precisely control chromatic dispersion of optical fiber transmission lines. Moreover, in wavelength division multiplexing transmission, it is further required to control dispersion slope.

An electric receiver has response speed of at most 50 to 60 GHz and, therefore, it is unable to directly convert optical pulse signals of 160 Gbps or more into electrical signals for the time being.

In conventional methods, some of ultra high-speed (e.g. 160 Gbps) optical pulse signals entered from an optical fiber transmission line are extracted to generate low-speed (e.g. from 10 to 40 Gbps) optical pulse signals, the low-speed optical pulse signals are converted to electrical signals, a bit error rate is calculated from the electrical signals, and accumulated chromatic dispersion is controlled to minimize the bit error rate. See, for instance, the following reference 1: Masahiro Daikoku, Tomohiro Otani, and Masatoshi Suzuki, “160-Gb/s Four WDM Quasi-Linear Transmission Over 225-km NZ-DSF With 75-km Spacing,” IEEE PHOTONICS TECHNOLOGY LETTERS, VOL. 15, NO. 8, August 2000, pp. 1165-1167.

Generally speaking, the quality of an optical pulse deteriorates when an ultra high-speed optical pulse is demultiplexed into low-speed optical pulses. Accordingly, in a conventional configuration, it was impossible to accurately monitor waveform distortion due to chromatic dispersion in an optical fiber transmission line. As a result, control of dispersion compensation was sometimes performed inaccurately.

### SUMMARY OF THE INVENTION

A dispersion compensation control method according to the invention is applied to an optical transmission system comprising an optical transmission line with chromatic dispersion characteristics, an optical transmitter to output a signal light into the transmission line, and an optical receiver to receive the signal light output from the optical transmission line, the optical receiver having a chromatic dispersion compensator to compensate chromatic dispersion of the signal light. In the dispersion compensation control method according to the invention, the optical transmitter outputs an OTDM signal light as a signal light into the optical transmission line, on the OTDM signal light a spectrum component of a predetermined frequency being superimposed. A photodetector capable of following the predetermined frequency converts the OTDM signal light output from the optical transmission line into an electrical signal. The predetermined frequency component is extracted from the electrical signal. Power of the extracted predetermined frequency component is measured. The chromatic dispersion compensator is controlled so that the power of the predetermined frequency component becomes lower. And the predetermined frequency is lower than a frequency corresponding to a bit rate of the OTDM signal light.

Preferably, the OTDM signal light is composed of a signal light in which pulse signal lights of a plurality of tributary channels are time-division-multiplexed, and the predetermined frequency is an integral multiple of a frequency corresponding to the base rate of the tributary channels. This configuration makes it easier to superimpose the spectrum component of the predetermined frequency on the OTDM signal and to reproduce the optical clock at the optical receiver for demultiplexing the OTDM signal light into each channel.

Preferably, by varying an optical phase or amplitude of at least one of the plurality of tributary channels from optical phases or amplitudes of the rest of the channels, the spectrum component of the predetermined frequency is superimposed on the OTDM signal light. This function is realized with a simple configuration.

Preferably, the step for controlling the chromatic dispersion compensator so that the power of the predetermined frequency component becomes lower controls first an amount of dispersion compensation of the dispersion compensator so that the power of the predetermined frequency becomes lower and thereafter dispersion slope of the dispersion compensator so that the power of the predetermined frequency becomes lower. With this operation, precise chromatic dispersion control suitable for receiving signals is realized.

A dispersion compensation controller according to the invention is applied to an optical transmission system comprising an optical transmission line with chromatic dispersion characteristics, an optical transmitter to output an OTDM signal light into the optical transmission line, on the OTDM signal light a spectrum component of a predetermined frequency being superimposed, and an optical receiver to receive the OTDM signal light output from the optical transmission line, the optical receiver having a chromatic dispersion compensator to compensate the chromatic dispersion of the OTDM signal light. Characteristically, the dispersion compensation controller according to the invention comprises a photodetector capable of following the predetermined frequency to convert the OTDM signal light output from the optical transmission line into an electrical signal, an electric filter to extract the predetermined component from the electrical signal output from the photodetector, a power monitor to measure power of the predetermined frequency component output from the electric filter, and a controller to control the chromatic dispersion compensator so that the power of the predetermined frequency component measured by the power monitor becomes lower.

Preferably, the OTDM signal light is composed of a signal light in which pulse signals of a plurality of tributary channels are time-division-multiplexed, and the predetermined frequency is an integral multiple of a frequency corresponding to the base rate of the tributary channels. This configuration makes it easier to superimpose the spectrum component of the predetermined frequency on the OTDM signal light and to regenerate the optical clock in the optical receiver for demultiplexing the OTDM signal light into respective channels.

Preferably, the spectrum component of the predetermined frequency is superimposed on the OTDM signal light by varying an optical phase or amplitude of at least one of the plurality of tributary channels from optical phases or amplitudes of the rest of the channels. Using this method, the spectrum component of the predetermined frequency is easily superimposed on the OTDM signal light with a simple configuration.

Preferably, the optical transmitter comprises a pulse light source to pulse-oscillate at a frequency of the base rate, an optical divider to divide the output pulse light from the pulse light source into a plurality of tributary channels, a plurality of data modulators to modulate each pulse light divided by the optical divider with respective transmission data, an optical adjuster to adjust so that an amplitude or optical phase of at least one pulse signal light of a predetermined channel within the pulse signal lights of the respective tributary channels generated by the plurality of data modulators is different from amplitudes or optical phases of the signal lights of the rest of the channels, and an optical multiplexer to time-division-multiplex the pulse signal lights of the respective tributary channels. By this configuration, the spectrum component of the predetermined frequency is easily superimposed on the OTDM signal light with a simple structure.

Preferably, the controller controls first an amount of dispersion compensation of the chromatic dispersion compensator so that the power of the predetermined frequency component measured by the power monitor becomes lower and thereafter dispersion slope of the dispersion compensator so that the power of the predetermined frequency component measured by the power monitor becomes lower. With this operation, precise chromatic dispersion control suitable for receiving signals is realized.

In an optical transmission method according to the invention, an OTDM signal light is generated in such manner that a plurality of pulse signal lights having a predetermined base rate are time-division-multiplexed to have a spectrum component of a predetermined frequency corresponding to an integral multiple of the base rate. The OTDM signal light is output into an optical transmission line having chromatic dispersion characteristics. The OTDM signal light output from the optical transmission line is split into two portions. One portion of the split OTDM signal lights is converted into an electrical signal by a photodetector capable of following the predetermined frequency. A component having the predetermined frequency is extracted from the electrical signal. The power of the extracted predetermined frequency component is measured. The chromatic dispersion compensator is controlled so that the power of the predetermined frequency component becomes lower. An optical clock having the predetermined frequency is generated from the electrical signal. The other portion of the split OTDM signal lights is demultiplexed into respective channels according to the generated optical clock.

Preferably, in the step for generating the OTDM signal light, the OTDM signal light having a spectrum component of a predetermined frequency corresponding to a frequency being an integral multiple of the base rate is generated by varying an optical phase or amplitude of at least one of the plurality of pulse signal lights from optical phases or amplitudes of the rest of the pulse signal lights. Accordingly, a spectrum component having a predetermined frequency is easily superimposed on an OTDM signal light with a simple configuration.

Preferably, the predetermined frequency equals to the frequency of the base rate. This also simplifies the regeneration of the optical clock in the optical receiver for demultiplexing into respective channels.

Preferably, in the step for controlling the chromatic dispersion compensator so that the power of the predetermined component becomes lower, amount of dispersion compensation of the dispersion compensator is first controlled so that the power of the predetermined frequency component becomes lower, and thereafter a dispersion slope of the dispersion compensator is controlled so that the power of the predetermined component becomes lower. This operation makes it possible to obtain the accurate chromatic dispersion control suitable for signal receiving.

An optical transmission system according to the invention comprises an optical transmission line having chromatic dispersion characteristics, an optical transmitter to output an OTDM signal light into the optical transmission line, on the OTDM signal light a spectrum component of a predetermined frequency being superimposed, and an optical receiver to receive the OTDM signal light output from the optical transmission line. Characteristically, the optical receiver comprises a chromatic dispersion compensator to compensate chromatic dispersion of the OTDM signal light, an optical splitter to split an output light from the chromatic dispersion compensator into two portions, a photodetector capable of following the predetermined frequency to convert one of the output lights from the optical splitter into an electrical signal, an electric filter to extract a component having the predetermined frequency out of the output from the photodetector, a power monitor to measure power of the predetermined frequency component output from the electric filter, a controller to control the chromatic dispersion compensator so that the power of the predetermined frequency component measured by the power monitor becomes lower, an optical clock generator to generate an optical clock having the predetermined frequency out of the electrical signal, an OTDM demultiplexer to demultiplex the other output light from the optical splitter into signal lights of respective channels according to the optical clock generated by the optical clock generator, and a receiver to receive the signal lights of the respective channels demultiplexed by the OTDM demultiplexer.

Preferably, the controller controls first an amount of dispersion compensation of the dispersion compensator so that the power of the predetermined frequency component measured by the power monitor becomes lower and thereafter dispersion slope of the dispersion compensator so that the power of the predetermined frequency component measured by the power monitor becomes lower. This operation makes it possible to realize precise chromatic dispersion control suitable for signal reception.

Preferably, the optical transmitter comprises a pulse light source to pulse-oscillate at a frequency of the base rate, an optical divider to divide an output pulse light from the pulse light source into a plurality of channels, a plurality of data modulators to modulate each pulse light divided by the optical divider with respective transmission data, an optical adjuster to adjust so that an amplitude or optical phase of at least one pulse signal light of a predetermined channel within the pulse signal lights of the respective channels generated by the plurality of data modulators is different from amplitudes or optical phases of the pulse signal lights of the rest of the channels, and an optical multiplexer to time-division-multiplex the pulse signal lights of the respective channels. Accordingly, a spectrum component having a predetermined frequency is easily superimposed on an OTDM signal light in a simple configuration.

According to the invention, it is possible to adequately control dispersion compensation of an ultra high-speed optical pulse signal that is too fast to be directly converted into an electrical signal. In addition, the invention realizes transmission of an ultra high-speed optical signal as fast as 160 Gbps.

### BRIEF DESCRIPTION OF THE DRAWINGS

The above and other objects, features and advantages of the present invention will be apparent from the following detailed description of explanatory embodiments of the invention in conjunction with the accompanying drawings, in which:

FIG. 1 is a schematic block diagram of an explanatory embodiment according to one embodiment of the invention;

FIG. 2 is a pulse waveform example of an OTDM pulse signal;

FIG. 3 is a spectrum example of an OTDM signal light having a 10 GHz component;

FIG. 4 is a spectrum example of an OTDM signal light having a 40 GHz component;

FIG. 5 is a schematic block diagram of a modified example of an optical transmitter 10; and

FIG. 6 is a measured example showing the relationship between chromatic dispersion in an optical transmission line and a tone component superimposed on an OTDM signal light.

### DETAILED DESCRIPTION

Explanatory embodiments of the invention are explained below in detail with reference to the drawings.

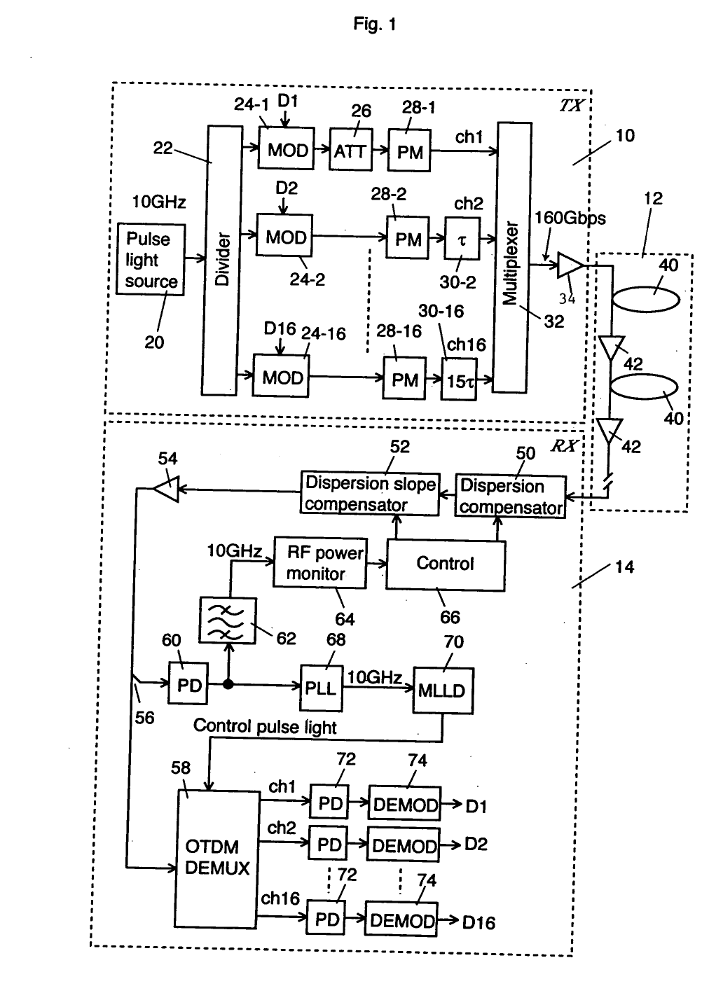

FIG. 1 shows a schematic block diagram of an optical transmission system in which an explanatory embodiment according to one embodiment of the invention is applied.

The optical transmission system according to the explanatory embodiment comprises an optical transmitter 10, an optical transmission line 12, and an optical receiver 14. In this explanatory embodiment, the optical transmitter 10 time-division-multiplexes 16 channels of 10 Gbps optical signals and outputs the multiplexed signals into the optical transmission line 12. Accordingly, an optical signal of 160 Gbps propagates in the optical transmission line 12.

The configuration and operation of the optical transmitter 10 is explained. A pulse light source 20 outputs an optical pulse having a single wavelength λs and a basic repetition frequency (a base rate) of 10 GHz. An optical divider 22 divides the output pulse from the pulse light source 20 into 16 waves, i.e. 16 channels, and supplies the channels to data modulators 24-1 through 24-16 respectively. The data modulator 24-1 binary-modulates optical intensity of the optical pulse from the optical divider 22 according to a data D1. Similarly, the data modulators 24-2 through 24-16 binary-demodulate optical intensity of the optical pulses from the optical divider 22 according to data D2 through D16 respectively. With this operation, the data modulators 24-1 through 24-16 output 10 Gbps optical pulse signals which carry the data D1 through D16 respectively.

In this explanatory embodiment, to transmit the 10 GHz tone signal from the optical transmitter 10 to the optical receiver 14, the optical intensity of the optical pulse signal light of channel 1 (ch1) is set lower than the optical intensity of the optical pulse signal lights of the other channels ch2 through ch16. For this purpose, an attenuator 26 having a predetermined attenuation factor is connected to the output of the data modulator 24-1. For example, 3% is satisfactory as the attenuation factor of the attenuator 26. For a reference regarding a method for transmitting a base rate clock and regenerating it on a receiving side, see, Tetsuya Miyazaki, Fumito Kubota, “Tone modulation using a passive OTDM multiplexer for clock recovery from a 160-Gbit/s OTDM signal”, The 10^{th} International Workshop on Femtosecond Technology, WC-3, Page 38, 2003. The entire contents of which are incorporated herein by reference.

A phase modulator 28-1 modulates an optical phase of the optical pulse signal of ch1 output from the attenuator 26, and the other phase modulators 28-2 through 28-16 modulate optical phases of the output signal lights from the data modulators 24-2 through 24-16 respectively. In optical pulse transmission, an optical frequency varies at rise time and fall time of an optical pulse because of self phase modulation (SPM). The variation of the optical frequency causes the variation of optical group speed to expand or contract the optical pulse in the time domain. By disposing the phase modulators 28-1 through 28-16, such deterioration of a pulse waveform is reduced.

Each of the output signal lights from the phase modulators 28-1 through 28-16 is multiplexed on a time slot different from the others. That is, optical delays 30-2 to 30-16, each having different delay time τ to 15τ respectively, are disposed on ch2 to ch16 and an optical multiplexer 32 multiplexes the pulse signal light of ch1 output from the phase modulator 28-1 and the pulse signal lights of ch2 to ch16 output from the optical delays 30-2 to 30-16. In this explanatory embodiment, the base delay time τ is 6.25 ps corresponding to a pulse interval of 160 Gb/s. The optical delays 30-2 to 30-16 and the optical multiplexer 32 function as a multiplexer to time-division-multiplex optical pulse signals of ch1 to ch16.

An optical amplifier 34 optically amplifies the output light, i.e. the optically time-division-multiplexed signal light of 160 Gbps (OTDM signal light), from the optical multiplexer 32, and outputs the amplified light into the optical transmission line 12.

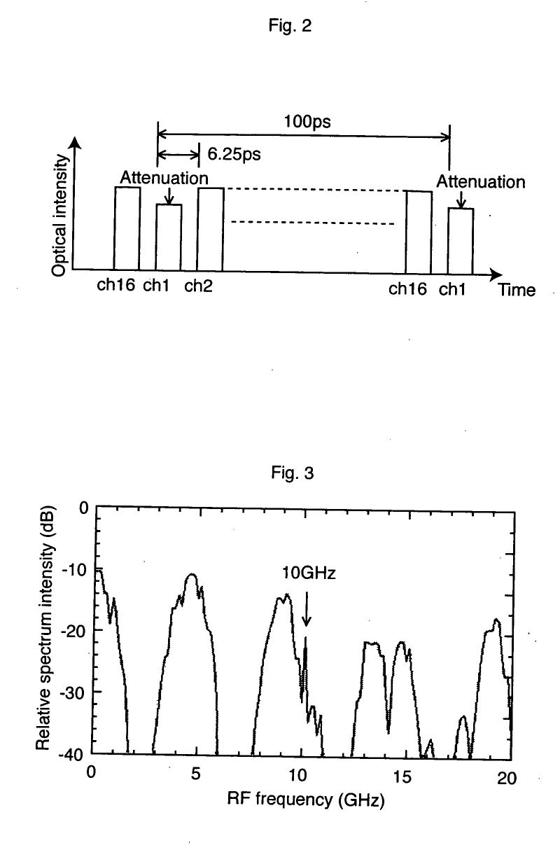

FIG. 2 shows a timing chart of an OTDM signal light output into the optical transmission line 12. The horizontal axis shows time, and the vertical axis shows optical intensity. As shown in FIG. 2, because of the attenuator 26, the optical intensity of the optical pulse signal of ch1 lowers compared to those of the optical pulse signals of ch2 to ch16. Consequently, the OTDM signal light output into the optical transmission line 12 includes an RF frequency component of 10 GHz as shown in FIG. 3. FIG. 3 shows a measured spectrum example of an OTDM signal light of 160 Gbps output into the optical transmission line 12. The horizontal axis shows the RF frequency, and the vertical axis shows the spectrum intensity (relative value).

The optical transmission line 12 is composed of a plurality of optical fibers 40 and optical amplifiers 42. Generally, the optical fiber 40 is composed of transmission optical fiber and dispersion compensating optical fiber. The OTDM signal light propagated in the optical transmission line 12 enters the optical receiver 14.

The configuration and operation of the optical receiver 14 is explained next. The OTDM signal light from the optical transmission line 12 enters an optical splitter 56 through a dispersion compensator 50, dispersion slope compensator 52, and an optical amplifier 54. The dispersion compensator 50 compensates the chromatic dispersion of the incident OTDM signal light accumulated in the optical transmission line 12. The dispersion slope compensator 52 compensates dispersion slope of the chromatic dispersion of the incident OTDM signal light accumulated in the optical transmission line 12.

The optical splitter 56 splits the OTDM signal light amplified by the optical amplifier 54 into two portions and applies one portion to an OTDM demultiplexer 58 and the other to a photodiode 60. The photodiode 60 converts the OTDM signal light from the optical splitter 56 into an electrical signal. As shown in FIG. 3, the OTDM signal light from the optical transmission line 12 has a tone component of 10 GHz. Accordingly, by using an element being capable of following 10 GHz although not capable of following 160 GHz as the photodiode 60, the electrical output from the photodiode 60 includes a frequency component of 10 GHz. A photodiode having such function can be easily obtained.

By varying amplitude of one of the tributary channels from amplitudes of the rest of the channels, a tone component of the base rate frequency is transmitted to the optical receiver 14. The influence of the chromatic dispersion in the optical transmission line 12 upon the OTDM signal light also affects the tone component of 10 GHz included in the OTDM signal light. Therefore, by monitoring the tone component, the waveform deterioration due to the chromatic dispersion of the OTDM signal light is easily monitored, and the chromatic dispersion and the dispersion slope are properly controlled.

For this purpose, in the explanatory embodiment, a precision electric bandpass filter 62 extracts the 10 GHz component out of the output from the photodiode 60, and an RF power monitor 64 measures the power of the output from the electric bandpass filter 60. A controller 66 controls the dispersion compensator 50 and the dispersion slope compensator 52 according to the power of the output from the RF power monitor 64, i.e. the power of the 10 GHz component propagated in the optical transmission line 12, so as to minimize the power. Specifically, the controller 66 controls an amount of dispersion compensation of the dispersion compensator 50 so that the output from the RF power monitor 64 becomes minimum, and thereafter controls the dispersion slope using the dispersion slope compensator 52 so that the output from the RF power monitor 64 becomes minimum.

As explained above, in this explanatory embodiment, the dispersion compensator 50 and the dispersion slope compensator 52 are controlled according to the power of the 10 GHz component propagated in the optical transmission line 12 and thereby the waveform deterioration of the OTDM signal light caused by the chromatic dispersion characteristics of the optical transmission line 12 is resolved or reduced.

The output from the photodiode 60 can be used to demultiplex the tributary signal into the respective channels. That is, a PLL circuit 68 generates a 10 GHz clock to phase-lock with the output from the photodiode 60 using a phase locked loop. The output from the PLL circuit 68 is applied to a mode-locked laser diode (MLLD) 70 as a drive signal. The MLLD 70 mode-locks with the output clock from the PLL 68 and produces a laser pulse so as to generate an optical clock of 10 GHz having a short pulse width. This optical clock is applied to the OTDM demultiplexer 58 as a control pulse light.

The OTDM demultiplexer 58 demultiplexes the OTDM optical signal from the optical splitter 56 into the signal lights of the respective channels ch1 to ch16 according to the control pulse light from the MLLD 70 and outputs the demultiplexed signal lights. An optical switch usable as the OTDM demultiplexer 58 is described in, for example, I. Shake et al., “160 Gbit/s full OTDM demultiplexing based FWM of SOA-array integrated on planer lightwave circuit,” Proc. 27^{th}, European Conference on Optical Communication (ECOC'01), Tul. 2. 2, pp. 182-183, 2001.

The signal light of each channel demultiplexed by the OTDM demultiplexer 58 is converted into an electrical signal by a photodiode 72. In each channel, a demodulator 74 demodulates the data D1 to D16 of the respective channels out of the output signal from the corresponding photodiode 72. If an error exists in the demodulated data, the demodulator 74 corrects the error as far as possible.

In the above explanatory embodiment, a signal light of 160 Gbps is generated by time-division-multiplexing 16 signal lights of 10 Gb/s. The subject invention, however, is also applicable to other multiplex numbers. The invention can be applied to 20 Gbps×8 and 40 Gbps×4, for instance. In addition, the data rate after the time-division-multiplexing is not limited to 160 Gbps. FIG. 4 shows an optical spectrum of an OTDM signal light of 160 Gbps obtained by multiplexing 4 waves of 40 Gbps. The horizontal axis expresses RF frequency, and the vertical axis expresses relative spectrum intensity. It shows the existence of a tone component of 40 GHz.

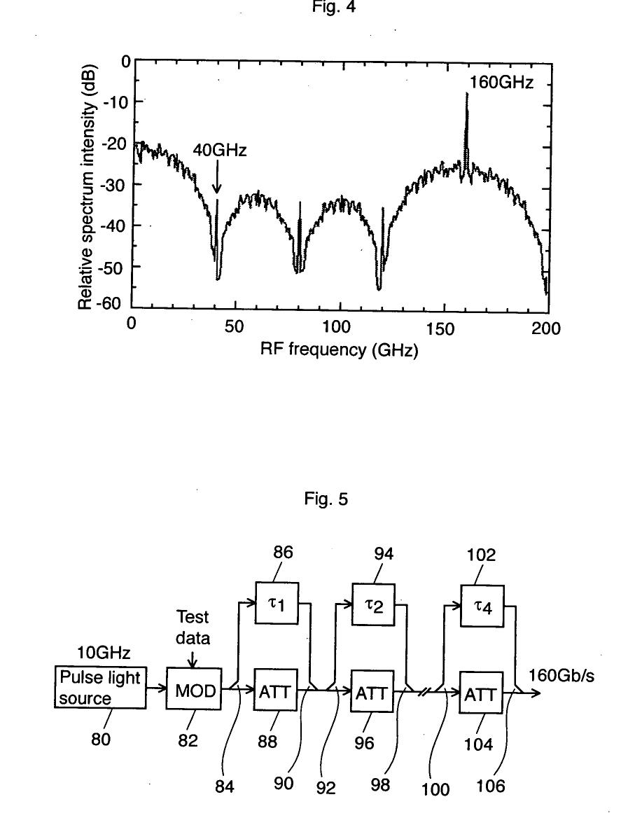

The optical transmitter 10 of the explanatory embodiment shown in FIG. 1 has a configuration for data transmission. In this embodiment, a test signal generator can be used instead of the optical transmitter 10 in terms of monitoring and controlling the chromatic dispersion characteristics of the optical transmission line 12. Such a configuration example using a test signal generator is shown in FIG. 5.

In the test signal generator shown in FIG. 5, a frequency is increased by alternately repeating splittings and delays. That is, a pulse light source 80 generates an optical clock pulse of 10 GHz which pulse width is short enough to follow 160 Gbps. A data modulator 82 modulates the output optical pulse from the pulse light source 80 with a test data.

The optical splitter 84 splits the output signal light from the data modulator 82 into two portions and applies one portion to an optical delay 86 of delay time τ₁ and the other portion to an attenuator 88. τ₁ is set to 50 ps. The attenuation factor of the attenuator 88 is set to balance with the attenuation in the optical delay 86. An optical combiner 90 combines the output lights from the optical delay 86 and the attenuator 88. The rate of the output signal light from the optical combiner 90 becomes 20 Gbps. The split ratio of the optical slitter 84 (or the attenuation factor of the attenuator 88) is adjusted so that the amplitude of an optical pulse signal to transmit the optical delay 86 are slightly different than the amplitude of an optical pulse signal to transmit the attenuator 88. Accordingly, a tone component of 10 GHz is superimposed on a finally obtained OTDM signal light of 160 Gbps.

In the second stage, an optical splitter 92 splits the output signal light from the optical combiner 90 into two portions and applies one portion to an optical delay 94 of delay time τ₁ and the other portion to an attenuator 96. Preferably, τ₂ is set to 25 ps. The attenuation factor of the attenuator 96 is set to balance with the attenuation in the optical delay 94. An optical combiner 98 combines the output lights from the optical delay 94 and the attenuator 96. The rate of the output signal from the optical combiner 98 becomes 40 Gbps.

The operations of the third stage and the fourth stage are basically the same as the operation of the second stage. The forth stage is a final stage. In the fourth stage, an optical splitter 100 splits an output signal light from an optical combiner (not illustrated) in the third stage into two portions and applies one portion to an optical delay 102 of a delay time τ₄ and the other to an attenuator 104. Preferably, τ₄ is set to 6.25 ps. The attenuation factor of the attenuator 104 is set to balance with the attenuation in the optical delay 102. An optical combiner 106 combines the output lights from the optical delay 102 and the attenuator 104. The rate of the output signal light from the optical combiner 106 becomes 160 Gbps.

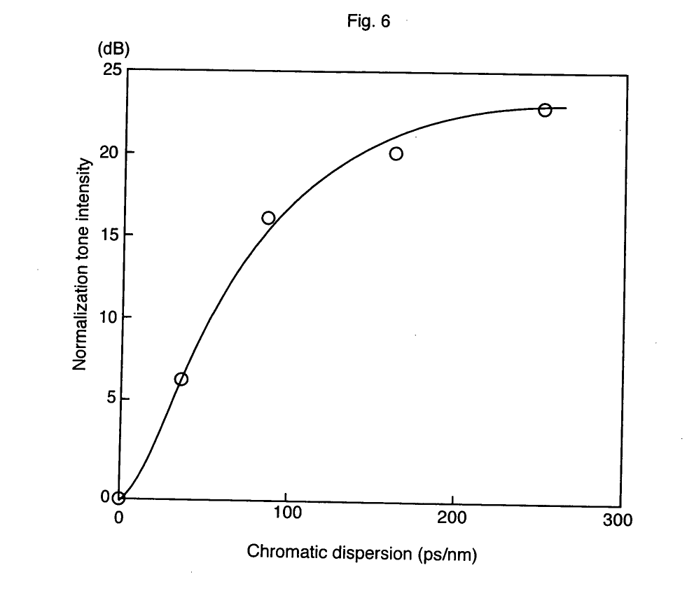

FIG. 6 shows a measured example of the relation between chromatic dispersion in an optical transmission line and intensity of a tone component being superimposed on an OTDM signal light. The horizontal axis expresses chromatic dispersion, and the vertical axis expresses relative intensity of a tone component, the intensity of a tone component is normalized with the intensity at a transmission terminal. FIG. 6 shows that the intensity of a tone component and a chromatic dispersion value are proportional at 300 ps/nm or less. This shows that a chromatic dispersion value can be estimated through monitoring the intensity of a tone component and, therefore, it is possible to operate appropriate dispersion compensation by controlling a chromatic dispersion compensator so as to reduce the intensity of a tone component.

In the above explanatory embodiment, although a frequency component of a base rate is superimposed on an OTDM signal light by varying pulse amplitude of one channel from pulse amplitudes of the other channels, it is also possible to vary optical phase of one channel from the others instead of varying the amplitude. In addition, a frequency component of a base rate can be superimposed on an OTDM signal light by varying the amplitudes or optical phases of half of the channels from the amplitudes or optical phases of the rest of the channels. All of such superimposing methods are applicable to this invention.

While the invention has been described with reference to the specific embodiment, it will be apparent to those skilled in the art that various changes and modifications can be made to the specific embodiment without departing from the spirit and scope of the invention as defined in the claims.

1. A method to control chromatic dispersion compensation in an optical transmission system comprising an optical transmission line with chromatic dispersion characteristics, an optical transmitter to output a signal light into the optical transmission line, and an optical receiver to receive the signal light output from the optical transmission line, the optical receiver having a chromatic dispersion compensator to compensate chromatic dispersion of the signal light, the method comprising:
outputting from the optical transmitter an OTDM signal light into the optical transmission line and superimposing on the OTDM signal, a spectrum component of a predetermined frequency;
converting the OTDM signal light output from the optical transmission line into an electrical signal using a photodetector capable of following the predetermined frequency;
extracting the predetermined frequency component out of the electrical signal;
measuring power of the extracted predetermined frequency component; and
controlling the chromatic dispersion compensator to lower the power of the predetermined frequency component,
wherein the predetermined frequency is lower than a frequency corresponding to a bit rate of the OTDM signal light.

2. The method of claim 1 wherein the OTDM signal light comprises a signal light in which pulse signal lights of a plurality of tributary channels are time-division-multiplexed and the predetermined frequency is an integral multiple of a frequency corresponding to a base rate of the tributary channels.

3. The method of claim 2 wherein the spectrum component having the predetermined frequency is superimposed on the OTDM signal light by varying an optical phase or amplitude of at least one of the plurality of tributary channels from optical phases or amplitudes of the remaining of the plurality of tributary channels.

4. The method of claim 1 wherein the step for controlling the chromatic dispersion compensator comprises controlling an amount of dispersion compensation of the chromatic dispersion compensator so that the power of the predetermined frequency component decreases, and controlling a dispersion slope of the chromatic dispersion compensator so that the power of the predetermined frequency component decreases.

5. A dispersion compensation controller in an optical transmission system comprising an optical transmission line with chromatic dispersion characteristics, an optical transmitter to output an OTDM signal light into the optical transmission line, on the OTDM signal light a spectrum component of a predetermined frequency being superimposed, and an optical receiver to receive the OTDM signal light output from the optical transmission line, the optical receiver having a chromatic dispersion compensator to compensate chromatic dispersion of the OTDM signal light, comprising:
a photodetector following the predetermined frequency to convert the OTDM signal light output from the optical transmission line into an electrical signal;
an electric filter to extract the predetermined frequency component out of the electrical signal output from the photodetector;
a power monitor to measure power of the predetermined frequency component from the electric filter; and
a controller to control the chromatic dispersion compensator so that the power of the predetermined frequency component measured by the power monitor decreases.

6. The dispersion compensator controller of claim 5 wherein the OTDM signal light comprises a signal light in which pulse signal lights of a plurality of tributary channels are time-division-multiplexed and the predetermined frequency is an integral multiple of a frequency corresponding to a base rate of the plurality of tributary channels.

7. The dispersion compensator controller of claim 6 wherein the spectrum component having the predetermined frequency is superimposed on the OTDM signal light by varying an optical phase or amplitude of at least one of the plurality of tributary channels from optical phases or amplitudes of the remaining of the plurality of tributary channels.

8. The dispersion compensator controller of claim 5 wherein the optical transmitter comprises a pulse light source to pulse-oscillate at a frequency of a base rate, an optical divider to divide the output pulse light from the pulse light source into a plurality of tributary channels, a plurality of data modulators to modulate the respective pulse lights divided by the optical divider with respective transmission data, an optical adjuster to adjust so that an amplitude or optical phase of at least one pulse signal light of a predetermined channel within the pulse signal lights of the respective tributary channels is different from amplitudes or optical phases of the pulse signal lights of the remaining of the plurality of tributary channels, and an optical multiplexer to time-division-multiplex the pulse signal lights of the respective tributary channels.

9. The dispersion compensator controller of claim 5 wherein the controller controls an amount of dispersion compensation of the chromatic dispersion compensator so that the power of the predetermined frequency component decreases, and controls a dispersion slope of the dispersion compensator so that the power of the predetermined frequency component decreases.

10. An optical transmission method comprising:
generating an OTDM signal light in which a plurality of pulse signal lights having a predetermined base rate are time-division-multiplexed, the OTDM signal light having a spectrum component of a predetermined frequency corresponding to a frequency of a integral multiple of the base rate;
outputting the OTDM signal light into an optical transmission line having chromatic dispersion characteristics;
splitting the OTDM signal light output from the optical transmission line into a first portion and a second portion;
converting the first portion of the split OTDM signal light into an electrical signal using a photodetector capable of following the predetermined frequency;
extracting the predetermined frequency component out of the electrical signal;
measuring power of the extracted predetermined frequency component;
controlling the chromatic dispersion compensator so that the power of the predetermined frequency component decreases;
generating an optical clock having the predetermined frequency out of the electrical signal; and
demultiplexing the second portion of the split OTDM signal into the respective channels according to the generated optical clock.

11. The method of claim 10 wherein the step for generating the OTDM signal light generates the OTDM signal light having a spectrum component of the predetermined frequency corresponding to a frequency of a integral multiple of the base rate by varying an amplitude or optical phase of at least one of the plurality of pulse signal lights from amplitudes or optical phases of the remaining of the plurality of pulse signal lights.

12. The method of claim 10 or 11 wherein the predetermined frequency corresponds to a frequency of the base rate.

13. The method of claim 10 wherein the step for controlling the chromatic dispersion compensator controls an amount of dispersion compensation of the chromatic dispersion compensator so that the power of the predetermined frequency component decreases, and controls a dispersion slope of the chromatic dispersion compensator so that the power of the predetermined frequency component decreases.

14. An optical transmission system comprising an optical transmission line with chromatic dispersion characteristics, an optical transmitter to output an OTDM signal light into the optical transmission line, on the OTDM signal light a spectrum component of a predetermined frequency being superimposed, and an optical receiver to receive the OTDM signal light output from the optical transmission line,
wherein the optical receiver comprises;
a chromatic dispersion compensator to compensate chromatic dispersion of the OTDM signal light;
an optical splitter to split an output light from the chromatic dispersion compensator into a first portion and a second portion;
a photodetector following the predetermined frequency to convert the first portion of the split output light from the optical splitter into an electrical signal;
an electric filter to extract the predetermined frequency component out of the electric signal output from the photodetector;
a power monitor to measure power of the predetermined frequency component output from the electric filter;
a controller to control the chromatic dispersion compensator so that the power of the predetermined frequency component to be measured by the power monitor decreases;
an optical clock generator to generate an optical clock having the predetermined frequency out of the electrical signal;
an OTDM demultiplexer to demultiplex the second portion of the output light from the optical splitter into the signal lights of the respective channels according to the optical clock generated by the optical clock generator; and
a receiver to receive the signal lights of the respective channels demultiplexed by the OTDM demultiplexer.

15. The system of claim 14 wherein the controller controls an amount of dispersion compensation of the chromatic dispersion compensator so that the power of the predetermined frequency component measured by the power monitor decreases, and controls a dispersion slope of the chromatic dispersion compensator so that the power of the predetermined frequency component measured by the power monitor decreases.

16. The system of claim 14 wherein the optical transmitter comprises a pulse light source to pulse-oscillate at a frequency of a base rate, an optical divider to divide the output pulse light from the pulse light source into a plurality of channels, a plurality of data modulators to modulate the respective pulse lights divided by the optical divider with respective transmission data, an optical adjuster to adjust so that an amplitude or optical phase of at least one pulse signal light of a predetermined channel within the pulse signal lights of the respective channels is different from amplitudes or optical phases of the pulse signal lights of the remaining of the channels; and an optical multiplexer to time-division-multiplex the pulse signal lights of the respective channels.
